(19) United States
(12) Patent Application Publication
(10) Pub. No.: US 2021/0127028 A1
(43) Pub. Date: Apr. 29, 2021

(54) IMAGE READING APPARATUS, NON-TRANSITORY COMPUTER-READABLE STORAGE MEDIUM STORING CONTROL PROGRAM FOR IMAGE READING APPARATUS, AND CONTROL METHOD OF IMAGE READING APPARATUS

(71) Applicant: SEIKO EPSON CORPORATION, Tokyo (JP)

(72) Inventor: Masami ISHIHARA, MATSUMOTO-SHI (JP)

(21) Appl. No.: 17/074,725

(22) Filed: Oct. 20, 2020

(30) Foreign Application Priority Data
Oct. 24, 2019 (JP) 2019-193106

(51) Int. Cl. H04N 1/10; H04N 1/00

(52) U.S. Cl. CPC H04N 1/1039; H04N 1/00496; H04N 1/00917; H04N 1/00588

(57) ABSTRACT

An image reading apparatus includes a main body that performs a scanning operation of sequentially reading a plurality of documents by a reading section that reads the plurality of documents and a document transport section that transports the plurality of documents to the reading section. The main body has a plurality of postures with different inclinations. The image reading apparatus includes a posture acquisition section that acquires posture information indicating the posture of the main body, and a controller that controls an operation of the document transport section. The controller interrupts the scanning operation when the posture indicated by the posture information is changed from a start of the scanning operation during the scanning operation.

The present application is based on, and claims priority from JP Application Serial Number 2019-193106, filed Oct. 24, 2019, the disclosure of which is hereby incorporated by reference herein in its entirety.

### BACKGROUND

### 1. Technical Field

The present disclosure relates to an image reading apparatus including a main body having a plurality of postures with different inclinations, and a technology for controlling the image reading apparatus.

### 2. Related Art

An image reading apparatus disclosed in JP-A-2019-83429 can switch a posture of a device main body including a reading unit that reads a medium. The device main body has a first posture in which a feeding tray has a first inclination angle and a second posture in which the feeding tray has a second inclination angle closer to horizontal than the first inclination angle or the feeding tray is horizontal. The first posture in which the inclination angle of the feeding tray is relatively large is a posture suitable for automatically feeding documents one by one from a document bundle because the document bundle set in the feeding tray is positioned by gravity. The second posture in which the inclination angle of the feeding tray is relatively small is a posture in which an operator can easily set the documents one by one on the feeding tray. Therefore, the advantages of the image reading apparatus differ depending on the posture.

When the posture of the device main body is inadvertently switched in the middle of a scanning operation of sequentially reading a plurality of documents, an error may occur in the document transportation due to the change of a transport path of the document, and a reading accuracy of the document may decrease.

### SUMMARY

According to an aspect of the present disclosure, there is provided an image reading apparatus including a main body that performs a scanning operation of sequentially reading a plurality of documents by a reading section that reads the plurality of documents and a document transport section that transports the plurality of documents to the reading section. The main body has a plurality of postures with different inclinations. The image reading apparatus includes a posture acquisition section that acquires posture information indicating the posture of the main body, and a controller that controls an operation of the document transport section. The controller interrupts the scanning operation when the posture indicated by the posture information is changed from a start of the scanning operation during the scanning operation.

According to another aspect of the present disclosure, there is provided a non-transitory computer-readable storage medium storing a control program for an image reading apparatus including a main body that performs a scanning operation of sequentially reading a plurality of documents by a reading section that reads the plurality of documents and a document transport section that transports the plurality of documents to the reading section. The main body has a plurality of postures with different inclinations. The control program causes a computer to realize a posture acquisition function of acquiring posture information indicating the posture of the main body, and a control function of controlling an operation of the document transport section. The control function interrupts the scanning operation when the posture indicated by the posture information is changed from a start of the scanning operation during the scanning operation.

According to still another aspect of the present disclosure, there is provided a control method of an image reading apparatus including a main body that performs a scanning operation of sequentially reading a plurality of documents by a reading section that reads the plurality of documents and a document transport section that transports the plurality of documents to the reading section. The main body has a plurality of postures with different inclinations. The control method includes a posture acquisition step of acquiring posture information indicating the posture of the main body, and a control step of controlling an operation of the document transport section. The control step includes interrupting the scanning operation when the posture indicated by the posture information is changed from a start of the scanning operation during the scanning operation.

### BRIEF DESCRIPTION OF THE DRAWINGS

FIG. 1 is a diagram schematically showing an example of a scanner including a main body in each holding posture.

FIG. 2 is a diagram schematically showing an example of a holding mechanism of the main body.

FIG. 3 is a diagram schematically showing an example of a mechanism of the main body.

FIG. 4 is a block diagram schematically showing a configuration example of an image reading apparatus including the scanner.

FIG. 5 is a block diagram schematically showing a configuration example of an information processing apparatus.

FIG. 6 is a flowchart showing an example of image processing performed by the image reading apparatus including the scanner and the information processing apparatus.

FIG. 7 is a diagram schematically showing an example of changes in a state of the scanner.

FIG. 8A is a diagram schematically showing an example of an interruption dialog, and FIG. 8B is a diagram schematically showing an example of an error dialog.

FIG. 9 is a flowchart showing an example of image processing performed by the image reading apparatus including the scanner and the information processing apparatus.

FIG. 10 is a flowchart showing an example of image processing performed by the image reading apparatus including the scanner and the information processing apparatus.

FIG. 11 is a diagram schematically showing an example of changes in the state of the scanner.

FIG. 12 is a flowchart showing an example of image processing performed by the scanner.

### DESCRIPTION OF EXEMPLARY EMBODIMENTS

Hereinafter, embodiments of the present disclosure will be described. Of course, the following embodiments merely exemplify the present disclosure, and not all the features shown in the embodiments are essential to the means for solving the disclosure.

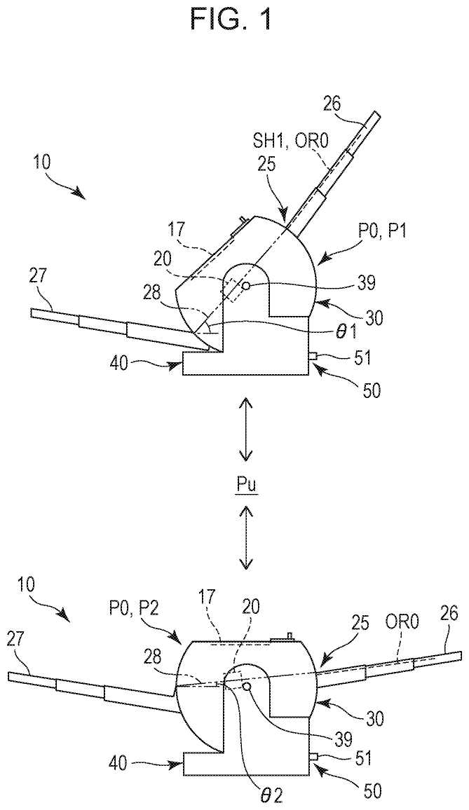

1. Outline of Technology Included in Present Disclosure: first, the outline of the technology included in the present disclosure will be described with reference to the examples shown in FIGS. 1 to 12. It should be noted that the drawings of the present application are diagrams schematically showing examples, the enlargement ratios in the respective directions shown in these drawings may be different, and the drawings may not match. Of course, each element of the present technology is not limited to the specific example indicated by the reference numeral. In the “Outline of Technology Included in Present Disclosure”, parentheses mean a supplementary explanation of the immediately preceding word.

Aspect 1: an image reading apparatus 1 according to an aspect of the present technology includes a main body 30 that performs a scanning operation of sequentially reading a plurality of documents ORO by a reading section 20 that reads the plurality of documents ORO and a document transport section 21 that transports the plurality of documents ORO to the reading section 20. The main body 30 has a plurality of postures P0 with different inclinations. The image reading apparatus 1 includes a posture acquisition section U1 that acquires posture information IM1 indicating the posture P0 of the main body 30, and a controller U2 that controls an operation of the document transport section 21. The controller U2 interrupts the scanning operation when the posture P0 indicated by the posture information IM1 is changed from a start of the scanning operation during the scanning operation.

In the above aspect, when the posture P0 of the main body 30 is changed from a start of the scanning operation during the scanning operation, the scanning operation is interrupted. Therefore, according to the above aspect, in the image reading apparatus including the main body having a plurality of postures with different inclinations, it is possible to suppress a situation in which a document cannot be read normally due to the change of the posture of the main body.

Here, the image reading apparatus includes a scanner, a facsimile, a multifunction machine having a document reading function and an image data output function, and the like. Further, the image reading apparatus includes a configuration in which a main body and a host device separate from the main body are coupled to each other in a wired or wireless manner.

The above mentioned remarks also apply to the following aspects.

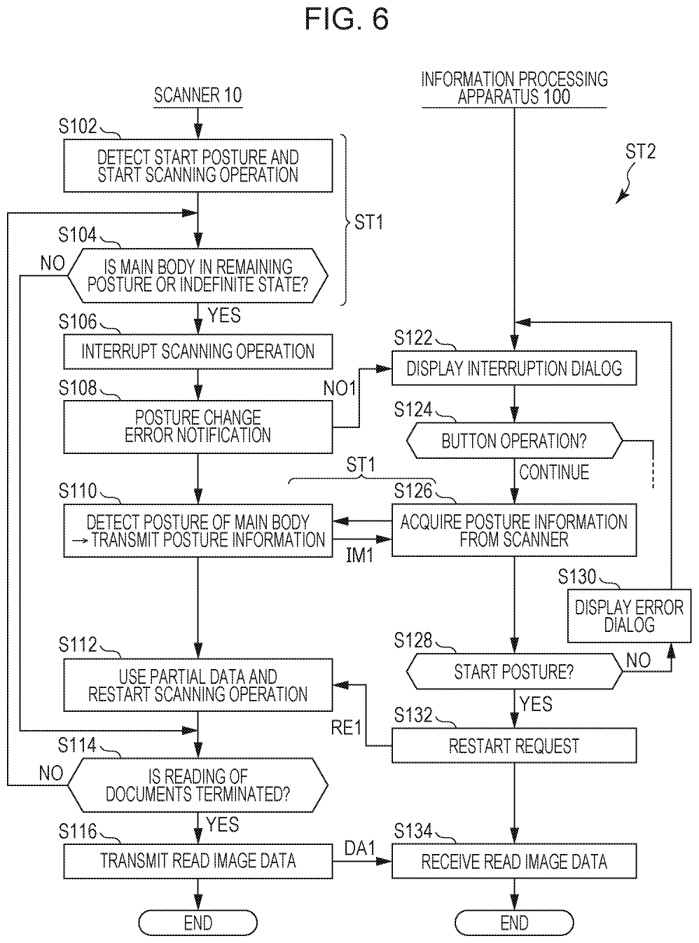

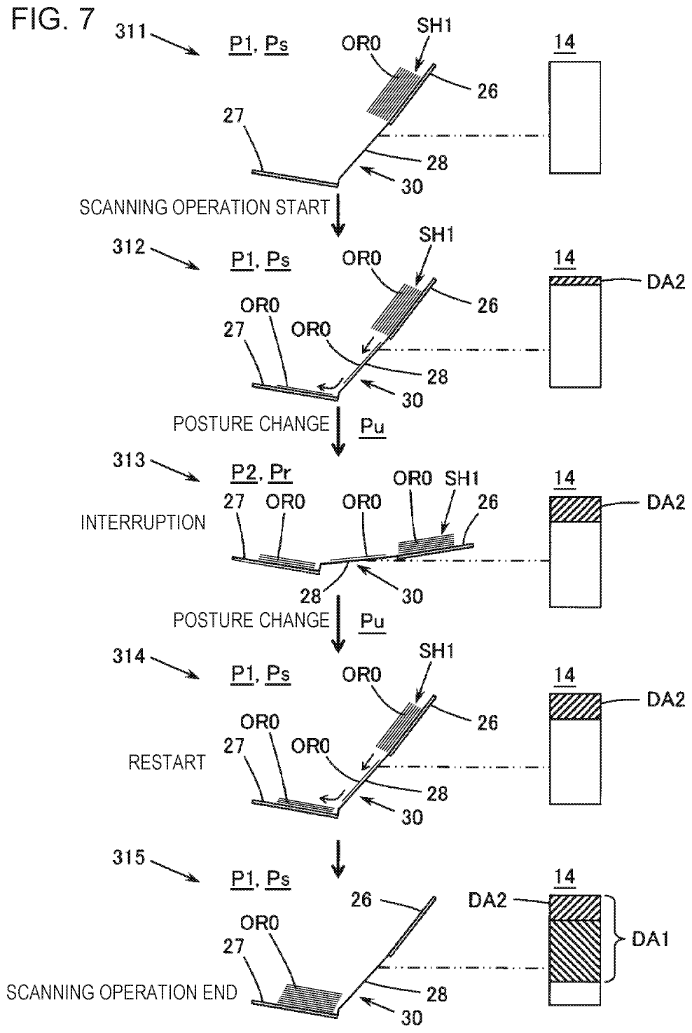

Aspect 2: in the plurality of postures P0, the posture P0 of the main body 30 at the start of the scanning operation is set as a start posture Ps, and the rest is set as a remaining posture Pr. As illustrated in FIGS. 6, 7, and the like, the controller U2 may interrupt the scanning operation when the posture P0 indicated by the posture information IM1 becomes one of the remaining posture Pr and an indefinite state Pu that is not any of the plurality of postures P0 during the scanning operation.

In the above aspect, when the posture P0 of the main body 30 becomes the remaining posture Pr or the indefinite state Pu during the scanning operation, the scanning operation is interrupted. Therefore, according to the above aspect, it is possible to provide a preferable configuration that suppresses a situation in which a document cannot be read normally due to the change of the posture of the main body.

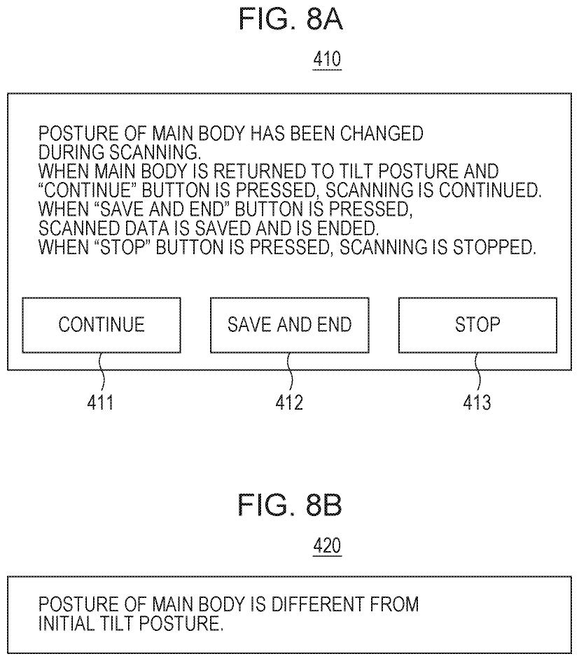

Aspect 3: as illustrated in FIGS. 6, 8A, and the like, the controller U2 may display, on a display portion 200, interruption information indicating interruption of the scanning operation (for example, an interruption dialog 410) when the posture P0 indicated by the posture information IM1 is changed from the start of the scanning operation during the scanning operation. According to the aspect, a user can perceive from the display of the interruption information (410) that normal reading cannot be performed due to the change of the posture P0 of the main body 30, and thus it is possible to improve convenience.

Aspect 4: further, as illustrated in FIGS. 6, 8A, 8B, and the like, the controller U2 may display, on the display portion 200, a message that the posture P0 of the main body 30 has been changed from the start of the scanning operation (for example, the dialogs 410 and 420) when the posture P0 indicated by the posture information IM1 is changed from the start of the scanning operation during the scanning operation. According to the aspect, the user can perceive that the posture P0 of the main body 30 has been changed from the start of the scanning operation, and thus it is possible to improve convenience.

Aspect 5: as illustrated in FIGS. 6, 7, and the like, the reading section 20 may read the plurality of documents ORO to generate read image data DA1. The controller U2 may complete the read image data DA1 including partial data DA2 by leaving the partial data DA2 generated by the reading section 20 and restarting the scanning operation when the posture P0 changed from the start of the scanning operation returns to an original posture during the scanning operation. As a result, even if the scanning operation is interrupted due to the change of the posture P0 of the main body 30, the partial data DA2 generated halfway is utilized by returning the posture P0 of the main body 30 to the original posture. Therefore, according to the present aspect, it is possible to improve convenience in the image reading apparatus including the main body having a plurality of postures with different inclinations.

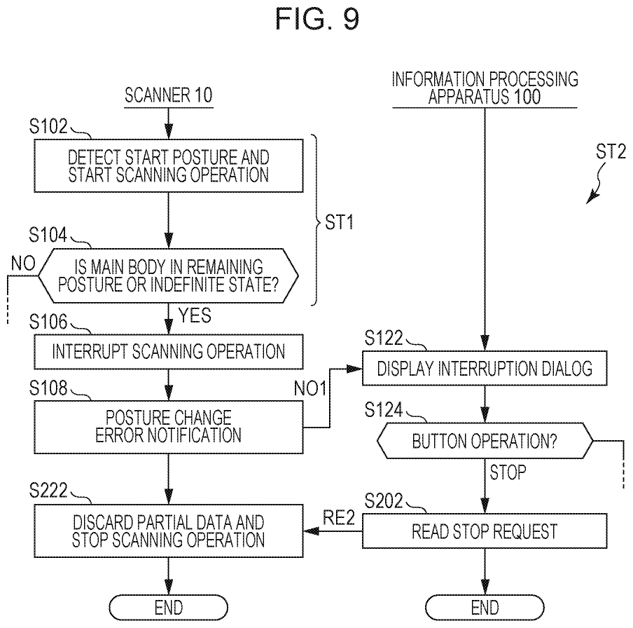

Aspect 6: as illustrated in FIGS. 8A and 9, the controller U2 may discard the partial data DA2 and stop the scanning operation when an instruction to stop the scanning operation (for example, an operation of a “stop” button 413) without using the partial data DA2 is received while the scanning operation is interrupted, during the scanning operation. As a result, while the scanning operation is interrupted due to the change of the posture P0 of the main body 30, the user can stop the scanning operation. Therefore, according to the present aspect, it is possible to further improve convenience in the image reading apparatus including the main body having a plurality of postures with different inclinations.

Aspect 7: as illustrated in FIGS. 8A, 10, and 11, the controller U2 may complete the read image data DA1 from the partial data DA2 and stop the scanning operation when an instruction to leave the partial data DA2 and to stop the scanning operation (for example, an operation of a “save and end” button 412) is received while the scanning operation is interrupted, during the scanning operation. As a result, while the scanning operation is interrupted due to the change of the posture P0 of the main body 30, the user can stop the scanning operation after acquiring the scanned read image data DA1. Therefore, according to the present aspect, it is possible to further improve convenience in the image reading apparatus including the main body having a plurality of postures with different inclinations.

Aspect 8: incidentally, a control program PRc for the image reading apparatus 1 according to an aspect of the present technology causes a computer (for example, the image reading apparatus 1) to realize a posture acquisition function FU1 corresponding to the posture acquisition section U1 and a control function FU2 corresponding to the controller U2. As in the above aspect, in the image reading apparatus including the main body having a plurality of postures with different inclinations, it is possible to provide a technology for suppressing a situation in which a document cannot be read normally due to the change of the posture of the main body.

Aspect 9: further, a control method of the image reading apparatus 1 according to an aspect of the present technology includes a posture acquisition step ST1 corresponding to the posture acquisition section U1 and a control step ST2 corresponding to the controller U2. As in the above aspect, in the image reading apparatus including the main body having a plurality of postures with different inclinations, it is possible to provide a technology for suppressing a situation in which a document cannot be read normally due to the change of the posture of the main body.

Furthermore, the present technology can be applied to an image reading system including an image reading apparatus, a control method of the image reading system, a control program for the image reading system, a computer-readable medium in which any one of the programs described above is recorded, and the like. The image reading apparatus may be composed of a plurality of distributed parts.

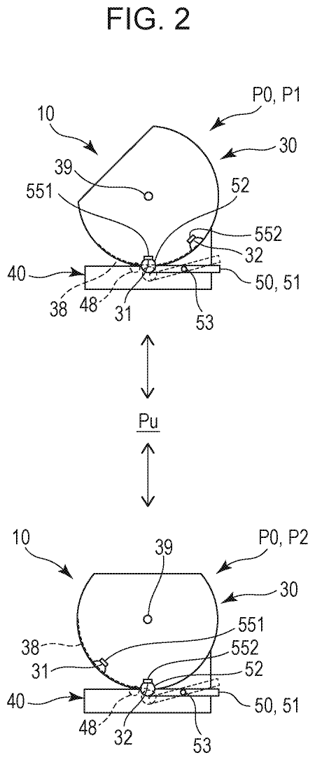

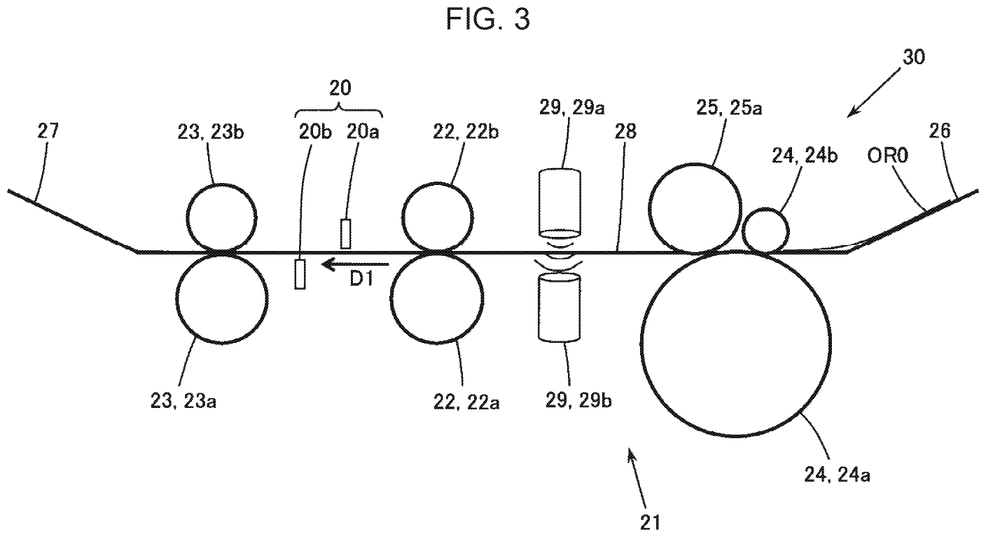

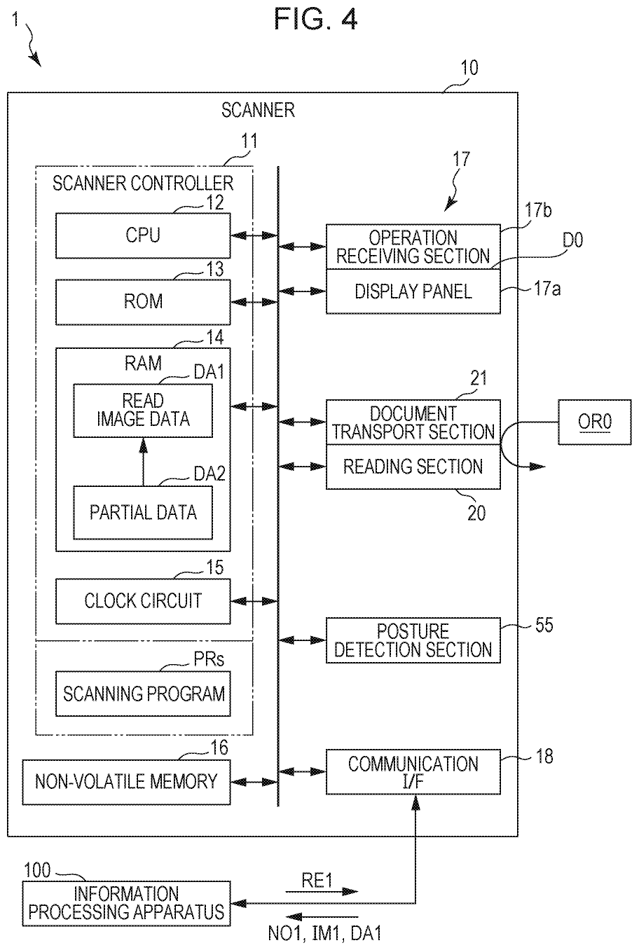

2. Specific Example of Image Reading Apparatus: FIG. 1 schematically illustrates a scanner 10 including a main body 30 that can take a plurality of postures P0 with different inclinations. The scanner 10 shown in FIG. 1 is a document scanner having an automatic paper feeding mechanism. FIG. 2 schematically illustrates a holding mechanism of the main body 30. FIG. 3 schematically illustrates a mechanism of the main body 30. FIG. 4 schematically illustrates a configuration of an image reading apparatus 1 including the scanner 10. The image reading apparatus 1 shown in FIG. 4 includes the scanner 10 and an information processing apparatus 100.

As shown in FIGS. 1 and 2, the scanner 10 includes the main body 30 that reads a document ORO, a support portion 40 of the main body 30, and a posture switching section 50 of the main body 30. The main body 30 includes a reading section 20 that reads the document ORO to generate read image data DA1, and a document transport section 21 that transports the document ORO to the reading section 20 along a transport path 28 passing through the reading section 20. The support portion 40 supports the main body 30. The posture switching section 50 can switch the main body 30 to the plurality of postures P0 with different inclinations. The plurality of postures P0 shown in FIGS. 1 and 2 include a first posture in which an average inclination angle θ1 of the transport path 28 with respect to the horizontal plane is relatively large, and a second posture in which an average inclination angle θ2 of the transport path 28 with respect to the horizontal plane is relatively small, and perform a scanning operation of sequentially reading the plurality of documents ORO. In FIGS. 1 and 2, a tilt posture P1 is shown as the first posture, and a flat posture P2 is shown as the second posture. Here, the main body may have a plurality of postures with different inclinations, and may have a third posture with a different inclination from both the first posture and the second posture, for example. In the present application, “first”, “second”, . . . are terms for identifying each component, and do not mean order.

The flat posture P2 may be a posture that satisfies 0≤θ2<θ1 and may be θ2=0, that is, a completely horizontal posture, or may be an inclined posture if the posture is closer to horizontal than the tilt posture P1. The tilt posture P1 is a posture suitable for automatically feeding the documents ORO one by one from a document bundle SH1 set on a feeding tray 26. The flat posture P2 is a posture suitable for reading a document such as thin paper, which has a low feeding accuracy in the feeding tray 26 having a steep inclination. The flat posture P2 is also a posture suitable for the operator to manually separate the documents one by one from the document bundle placed near the scanner 10 and set them on the feeding tray 26.

The main body 30 is in an indefinite state Pu capable of tilting when it is neither in the tilt posture P1 nor in the flat posture P2. Therefore, the main body 30 is in the indefinite state Pu when it is switched from the tilt posture P1 to the flat posture P2, and is also in the indefinite state Pu when it is switched from the flat posture P2 to the tilt posture P1.

As shown in FIG. 2, the main body 30 including the reading section 20 and the document transport section 21 has lock holes 31 and 32, a rack 38, and position sensors 551 and 552, and is supported so as to be tiltable with respect to the support portion 40 about a rotation shaft 39. The position sensors 551 and 552 are examples of a posture detection section 55 shown in FIG. 4. When a lock arm 52 of the posture switching section 50 enters either one of the lock holes 31 and 32, the main body 30 is held in any one of the plurality of holding postures P0. When the lock arm 52 enters the first lock hole 31, the main body 30 is held in the tilt posture P1. When the lock arm 52 enters the second lock hole 32, the main body 30 is held in the flat posture P2. The rack 38 meshes with a pinion 48 of the support portion 40. The rack mechanism including the rack 38 and the pinion 48 has a function of smoothly tilting the main body 30 about the rotation shaft 39. The position sensors 551 and 552 are arranged in the lock holes 31 and 32, respectively. The first position sensor 551 present in the first lock hole 31 detects whether or not the main body 30 is locked in the tilt posture P1. The second position sensor 552 present in the second lock hole 32 detects whether or not the main body 30 is locked in the flat posture P2. As the position sensors 551 and 552, a non-contact sensor such as an optical sensor or a magnetic sensor, a contact sensor such as a limit switch, or the like can be used.

The reading section 20 includes a light source that irradiates the document ORO on the transport path 28 with light, image sensors 20a and 20b that perform photoelectric conversion, a light receiving optical system that guides reflected light from the document ORO to the image sensors 20a and 20b, an analog-digital conversion section that converts analog electric signals output from the image sensors 20a and 20b into a digital pixel value group, an image data storage processor that stores the read image data DA1 based on the pixel value group in a RAM 14, and the like. In the reading section 20 shown in FIG. 1, the front surface image sensor 20a reads the front surface of the document ORO, and the back surface image sensor 20b reads the back surface of the document ORO. When the light reflected from an object appearing on the document ORO is converted into an electric signal by the image sensors 20a and 20b through the light receiving optical system, the read image data DA1 based on the pixel value group output from the image sensors 20a and 20b is stored in the RAM 14. Therefore, the read image data DA1 is obtained by reading the document ORO transported by the document transport section 21, and the read image data DA1 is temporarily stored in the RAM 14. In this way, the reading section 20 reads the document ORO to generate the read image data DA1.

As shown in FIG. 3, the document transport section 21 includes the feeding tray 26, a paper feed roller pair 24, a document separating section 25, a double feed detection section 29, a transport roller pair 22, a paper discharge roller pair 23, and a paper discharge tray 27.

The feeding tray 26 is expandable and contractable, and supplies the set document ORO to the transport path 28. On the feeding tray 26, the document bundle SH1 in which the plurality of documents ORO are overlapped may be set. The document transport section 21 that continuously feeds the plurality of documents ORO to the reading section 20 is called an ADF or an automatic paper feeder. Here, ADF is an abbreviation for auto document feeder.

The paper feed roller pair 24 includes a driving paper feed roller 24a which is in contact with one surface of the document ORO, for example, the back surface shown in FIG. 3, and a driven paper feed roller 24b which is in contact with the other surface of the document ORO, for example, the front surface shown in FIG. 3. The paper feed roller pair 24 transports the nipped document ORO in a transport direction D1 by the rotation of the driving paper feed roller 24a. At this time, the driven paper feed roller 24b is rotated by the movement of the document ORO.

The document separating section 25 includes a separating roller 25a and a pressing mechanism (not shown) that presses the separating roller 25a toward the driving paper feed roller 24a. When the pressing mechanism presses the separating roller 25a toward the driving paper feed roller 24a, the document separating section 25 separates only the lowermost document among the plurality of documents ORO at the time when the plurality of documents ORO enter between the driving paper feed roller 24a and the separating roller 25a, and allows the lowermost document to be transported in the transport direction D1. Therefore, the document separating section 25 performs an operation of separating the document ORO from the document bundle SH1 supported by the feeding tray 26. The document separating section 25 functions when the separating roller 25a is pressed toward the driving paper feed roller 24a, and the document separating section 25 does not function when the separating roller 25a is separated from the driving paper feed roller 24a.

The double feed detection section 29 includes an ultrasonic wave transmitting section 29a facing one surface of the document ORO, for example, the front surface shown in FIG. 3, and an ultrasonic wave receiving section 29b facing the other surface of the document ORO, for example, the back surface shown in FIG. 3. When the ultrasonic wave receiving section 29b receives ultrasonic waves transmitted from the ultrasonic wave transmitting section 29a, the double feed detection section 29 detects whether or not the plurality of documents ORO are fed from the paper feed roller pair 24 in an overlapping state.

The transport roller pair 22 includes a driving transport roller 22a which is in contact with one surface of the document ORO, for example, the back surface shown in FIG. 3, and a driven transport roller 22b which is in contact with the other surface of the document ORO, for example, the front surface shown in FIG. 3. The transport roller pair 22 transports the nipped document ORO toward the reading section 20 by the rotation of the driving transport roller 22a. At this time, the driven transport roller 22b is rotated by the movement of the document ORO.

The paper discharge roller pair 23 includes a driving paper discharge roller 23a which is in contact with one surface of the document ORO, for example, the back surface shown in FIG. 3, and a driven paper discharge roller 23b which is in contact with the other surface of the document ORO, for example, the front surface shown in FIG. 3. The paper discharge roller pair 23 transports the nipped document ORO toward the paper discharge tray 27 by the rotation of the driving paper discharge roller 23a. At this time, the driven paper discharge roller 23b is rotated by the movement of the document ORO.

The paper discharge tray 27 is expandable and contractable, and the set document ORO discharged from the transport path 28 is placed thereon.

Note that, although the document ORO is typically paper, it may be a sheet medium such as a synthetic resin sheet. Objects appearing in the document ORO include characters, photographs, paintings, and the like. Here, a blank sheet may be mixed in the document ORO.

As shown in FIGS. 1 and 2, the support portion 40 includes the pinion 48 that meshes with the rack 38, and supports the main body 30 so as to be tiltable about the rotation shaft 39. A posture switching lever 51 that is tiltable about a lever rotation shaft 53 is attached to the support portion 40. One end of the posture switching lever 51 extends from the support portion 40, and the above-described lock arm 52 is fixed to the other end of the posture switching lever 51. A force is applied to the posture switching lever 51 in a direction of pushing the lock arm 52 toward the main body 30 by an elastic mechanism (not shown). The lock arm 52 enters the first lock hole 31 when the main body 30 is in the tilt posture P1, and enters the second lock hole 32 when the main body 30 is in the flat posture P2. When a user raises one end of the posture switching lever 51 with a finger, the lock arm 52 is disengaged from the lock holes 31 and 32, and the main body 30 can be tilted. When the lock arm 52 is not in any of the lock holes 31 and 32, the main body 30 is in an indefinite state Pu in which it can be tilted, which is not in any of the plurality of postures P0.

The scanner 10 shown in FIG. 4 includes, as an electric system, a CPU 12 which is a processor, a ROM 13 which is a semiconductor memory, the RAM 14 which is a semiconductor memory, a clock circuit 15, a non-volatile memory 16, an operation panel 17, the reading section 20, the document transport section 21, the posture detection section 55, and a communication interface 18. Here, the CPU is an abbreviation for central processing unit, the ROM is an abbreviation for read only memory, the RAM is an abbreviation for random access memory, and the I/F shown in FIG. 4 is an abbreviation for interface. A scanning program PRs that causes the computer to function as the scanner 10 is stored in at least one of the ROM 13 and the non-volatile memory 16, and is executed by the CPU 12. The CPU 12 executes the scanning program PRs while using the RAM 14 as a work area, thereby performing various kinds of processing such as control processing of the operation panel 17, control processing of the reading section 20, control processing of the document transport section 21, and output processing of the read image data DA1 which is read data of the document ORO. The elements 12 to 15 described above are examples of a scanner controller 11. The processor configuring the scanner controller 11 is not limited to one CPU, and may be a plurality of CPUs, a hardware circuit such as an ASIC, a combination of a CPU and a hardware circuit, or the like. Here, ASIC is an abbreviation for application specific integrated circuit. The RAM 14 includes a buffer that temporarily stores the read image data DA1.

As the non-volatile memory 16, a semiconductor memory such as a flash memory, a magnetic recording medium such as a hard disk, or the like can be used. When the non-volatile memory 16 stores the scanning program PRs, it becomes a computer-readable medium in which the scanning program PRs is recorded.

The operation panel 17 includes a display panel 17a that displays a screen D0, and an operation receiving section 17b that receives an operation on the screen D0. A display panel such as a liquid crystal panel can be used as the display panel 17a. As the operation receiving section 17b, a touch panel attached to the front surface of the display panel 17a, a hard key including a keyboard, or the like can be used. The operation panel 17 is disposed on the front surface of the main body 30.

The communication interface 18 transmits and receives data to and from the information processing apparatus 100 connected in a wired or wireless manner according to a predetermined communication protocol. The communication interface 18 receives a restart request RE1 and the like from the information processing apparatus 100, and transmits a posture change error notification N01, posture information IM1, the read image data DA1, and the like to the information processing apparatus 100. Here, when the posture detection section 55 detects that the posture P0 of the main body 30 is switched during the scanning operation, the scanner 10 transmits the posture change error notification NO1 to the information processing apparatus 100, acquires the posture information IM1 indicating the detected posture P0 from the posture detection section 55, and transmits the acquired posture information IM1 to the information processing apparatus 100. Further, when the read image data DA1 is generated, the scanner 10 transmits the read image data DA1 to the information processing apparatus 100.

The connection between the communication interface 18 and the information processing apparatus 100 may be a network connection such as a LAN or the Internet, or a local connection such as a USB connection. Here, LAN is an abbreviation for local area network, and USB is an abbreviation for universal serial bus.

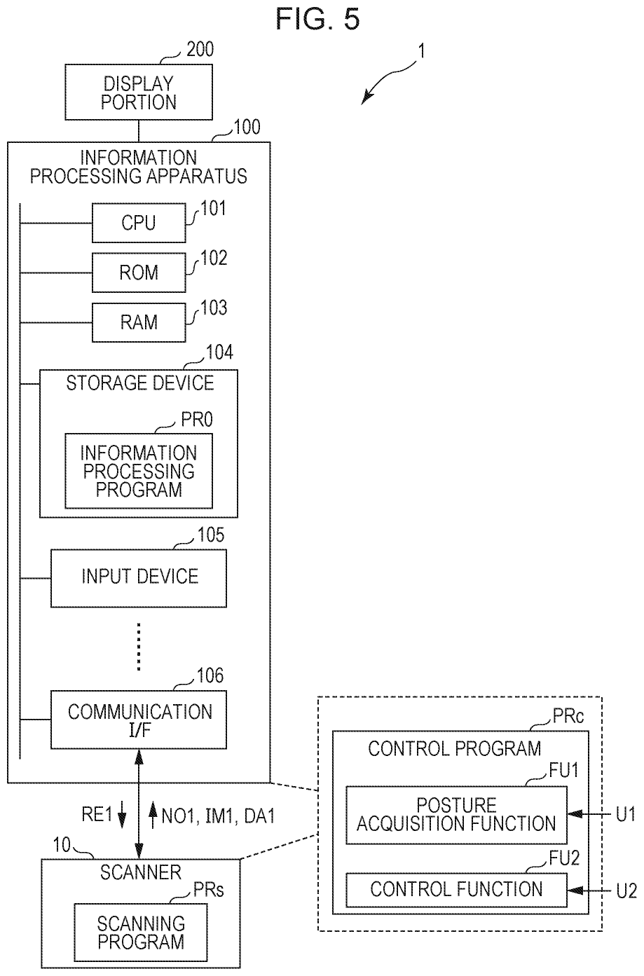

FIG. 5 schematically illustrates the configuration of the information processing apparatus 100 included in the image reading apparatus 1 according to the present specific example. The information processing apparatus 100 shown in FIG. 5 includes, as an electric system, a CPU 101 which is a processor, a ROM 102 which is a semiconductor memory, a RAM 103 which is a semiconductor memory, a storage device 104, an input device 105, and a communication interface 106. An information processing program PRO that causes a computer to function as the information processing apparatus 100 is stored in the storage device 104, read by the CPU 101 into the RAM 103, and executed by the CPU 101. The information processing program PRO is sometimes called driver software for controlling the scanner 10, and is also called a scanner driver. The CPU 101 executes the information processing program PRO while using the RAM 103 as a work area, thereby causing the information processing apparatus 100 to realize various functions and performing various kinds of processing. Note that, the processor configuring the information processing apparatus 100 is not limited to one CPU, and may be a plurality of CPUs, a hardware circuit such as an ASIC, a combination of a CPU and a hardware circuit, or the like.

The information processing program PRO and the scanning program PRs described above are examples of a control program PRc for the image reading apparatus 1. A plurality of functions realized by the control program PRc in the image reading apparatus 1 include a posture acquisition function FU1, and a control function FU2.

As the storage device 104 that stores the information processing program PRO, a semiconductor memory such as a flash memory, a magnetic recording medium such as a hard disk, or the like can be used. When the storage device 104 stores the information processing program PRO, it becomes a computer-readable medium in which the information processing program PRO is recorded. Therefore, the storage device 104 of the information processing apparatus 100 and the non-volatile memory 16 of the scanner 10 serve as a computer-readable medium in which the control program PRc for the image reading apparatus 1 is recorded.

As the input device 105, a pointing device, a hard key including a keyboard, a touch panel attached to the front surface of the display panel, or the like can be used. The communication interface 106 is connected to the communication interface 18 of the scanner 10 in a wired or wireless manner, and transmits and receives data to and from the scanner 10 according to a predetermined communication protocol. The communication interface 106 transmits the restart request RE1 and the like to the scanner 10, and receives the posture change error notification N01, the posture information IM1, the read image data DA1, and the like from the scanner 10. As described above, the connection between the communication interfaces 106 and 18 may be a network connection such as a LAN or the Internet, or a local connection such as a USB connection.

Note that, the information processing apparatus 100 includes a computer such as a personal computer including a tablet terminal, a mobile phone such as a smartphone, and the like. For example, when a computer body of a desktop personal computer is applied to the information processing apparatus 100, a display portion 200 is usually coupled to the computer body. When the information processing apparatus 100 outputs display data to the display portion 200, the display portion 200 displays a screen according to the display data. Even when a display-integrated computer such as a notebook personal computer is applied to the information processing apparatus 100, the information processing apparatus 100 is still outputting display data to the internal display portion 200. In addition, the information processing apparatus 100 may have all the components in one housing, but may be composed of a plurality of devices which are communicably divided. Further, the present technology can be implemented even when at least a portion of the scanner 10 is inside the information processing apparatus 100.

Incidentally, in a document scanner with an automatic paper feeding mechanism, there are a product used to automatically feed a plurality of documents together, and a product that is difficult to feed automatically, such as waste paper, and is used to automatically feed a large number of documents one by one by hand. However, it is troublesome for a user who wants to use each application depending on the case, because it is necessary to switch and use each driver software to operate two types of products. One scanner 10 according to the present specific example can automatically feed a plurality of documents together when the main body 30 is in the tilt posture P1, and automatically feed a large number of documents by hand one by one when the main body 30 is in the flat posture P2.

Here, it is assumed that since the posture switching section 50 of the main body 30 is in the scanner 10, the user mistakenly changes the posture P0 of the main body 30 during the scanning operation in which the reading section 20 and the document transport section 21 sequentially read the plurality of documents ORO. For example, when the main body 30 is inadvertently switched from the tilt posture P1 to the flat posture P2 while the documents ORO are being fed one by one from the document bundle SH1 set on the feeding tray 26, the document bundle SH1 remaining on the feeding tray 26 is not subjected to the positioning action due to gravity. In this way, when the posture P0 of the main body 30 is inadvertently switched in the middle of a scanning operation, an error may occur in the feeding of the document ORO due to the change of the inclination of the transport path 28, and a reading accuracy of the document ORO may decrease.

Therefore, in the image reading apparatus 1 according to the present specific example, when the posture P0 of the main body 30 is changed from a start of the scanning operation during the scanning operation, the scanning operation is interrupted. As a result, it is possible to suppress the situation where the document cannot be read normally due to the change of the posture P0 of the main body 30.

Further, when the posture P0 of the main body 30 is switched while the document ORO is being read from the document bundle SH1, it is conceivable to stop the scanning operation and then discard the read image data generated halfway. However, when the partial data of the read image data is discarded, even if the user returns the posture P0 of the main body 30 to the original posture, the user needs to perform the work of reading all the documents ORO included in the document bundle SH1 again from the beginning. It is troublesome to always perform this work.

Therefore, if the posture P0 of the main body 30 returns to the original posture when the scanning operation is interrupted, the image reading apparatus 1 according to the present specific example completes the read image data including partial data by leaving the partial data generated halfway and restarting the scanning operation. As a result, the partial data generated halfway is utilized, and the work of reading all the documents ORO again from the beginning is unnecessary. Further, when the posture P0 of the main body 30 is not returned to the original posture, the scan settings may be inconsistent. In this case, the image reading apparatus 1 determines that the scanning operation cannot be restarted and does not cancel the interrupted state of the scanning operation. As a result, it is possible to prompt the user to return the posture P0 of the main body 30 to the original posture.

3. Specific Example of Processing Performed by Information Processing Apparatus: FIG. 6 illustrates image processing performed by the image reading apparatus 1 including the scanner 10 and the information processing apparatus 100. This processing starts when the scanner 10 is instructed to read the plurality of documents ORO. Here, steps S102 to S104, S110, and S126 correspond to a posture acquisition section U1, the posture acquisition function FU1, and a posture acquisition step ST1. Steps S106 to S108, S112 to S116, S122 to S124, and S128 to S134 correspond to a controller U2, the control function FU2, and a control step ST2. Hereinafter, the description of “step” is omitted, and the reference numeral of each step is shown in parentheses.

FIG. 7 schematically illustrates states 311 to 315 of the scanner 10 that changes according to the image processing shown in FIG. 6.

First, the scanner 10 acquires the posture information IM1 indicating a start posture Ps of the main body 30 from the posture detection section 55, drives the document transport section 21, and starts the scanning operation of sequentially reading the plurality of documents ORO by the reading section 20 and the document transport section 21 (S102). For example, when the tilt posture P1 is the start posture Ps, as shown in FIG. 7, in the initial state 311, the document bundle SH1 is set on the feeding tray 26 of the main body 30 in the tilt posture P1. When a scan start button (not shown) on the scanner 10 or the information processing apparatus 100 is operated, the scanning operation starts, and as shown in the state 312 in FIG. 7, the plurality of documents ORO included in the document bundle SH1 are transported one by one by the document transport section 21 along the transport path 28. The scanner 10 generates partial data DA2, which is partial read image data, in the RAM 14 by reading the transported documents ORO one by one by the reading section 20. The partial data DA2 increases in page units, that is, in units of one document.

After the scanning operation is started, the scanner 10 acquires the posture information IM1 indicating the posture P0 of the main body 30 from the posture detection section 55, and branches the processing depending on whether or not the posture P0 indicated by the posture information IM1 is one of the remaining posture Pr and the indefinite state Pu (S104). When the posture P0 indicated by the posture information IM1 is the start posture Ps, the scanner 10 proceeds the processing to S114 without performing the processing of S106 to S112. When the posture P0 of the main body 30 remains the start posture Ps, the processing of S104 and S114 is repeated, and when the reading of all the documents ORO is terminated, the read image data DA1 is transmitted from the scanner 10 to the information processing apparatus 100 in S116 and S134.

In the determination processing of S104, when the posture P0 indicated by the posture information IM1 is one of the remaining posture Pr and the indefinite state Pu, the scanner 10 proceeds the processing to S106. In S106, the scanner 10 interrupts the scanning operation. FIG. 7 shows the state 313 in which the main body 30 is switched from the tilt posture P1 which is the start posture Ps to the flat posture P2 which is the remaining posture Pr during the scanning operation through the indefinite state Pu. Here, when the indefinite state Pu is detected by the posture detection section 55, the scanning operation is interrupted at the time of detecting the indefinite state Pu, and when the remaining posture Pr is detected by the posture detection section 55, the scanning operation is interrupted at the time of detecting the remaining posture Pr.

After the scanning operation is interrupted, the scanner 10 transmits, to the information processing apparatus 100, the posture change error notification NO1 indicating that the scanning operation is interrupted due to the posture P0 of the main body 30 being changed from the start posture Ps (S108). The information processing apparatus 100 that has received the posture change error notification NO1 displays, on the display portion 200, an interruption dialog 410 as illustrated in FIG. 8A (S122).

The interruption dialog 410 shown in FIG. 8A is information indicating an error during the scanning operation, and is an example of interruption information indicating interruption of the scanning operation. The interruption dialog 410 has a message that the posture P0 of the main body 30 has been changed from the start of the scanning operation, such as “The posture of the main body has been changed during scanning”, and buttons 411 to 413. The “continue” button 411 is an operation button that receives an instruction to restart the scanning operation on the assumption that the posture P0 of the main body 30 is returned to the original start posture Ps. The “save and end” button 412 is an operation button that receives an instruction to stop the scanning operation after completing the read image data DA1 from the partial data DA2. The “stop” button 413 is an operation button that receives an instruction to stop the scanning operation without leaving the partial data DA2.

When the start posture Ps is the tilt posture P1, the interruption dialog 410 may include a message urging the main body 30 to return to the tilt posture P1, such as “When the main body is returned to the tilt posture and the “continue” button is pressed, the scanning is continued” as shown in FIG. 8A. Of course, when the start posture Ps is the flat posture P2, the interruption dialog 410 may include a message urging the main body 30 to return to the flat posture P2, such as “When the main body is returned to the flat posture and the “continue” button is pressed, the scanning is continued”. In any case, the display examples are easy for the user to understand.

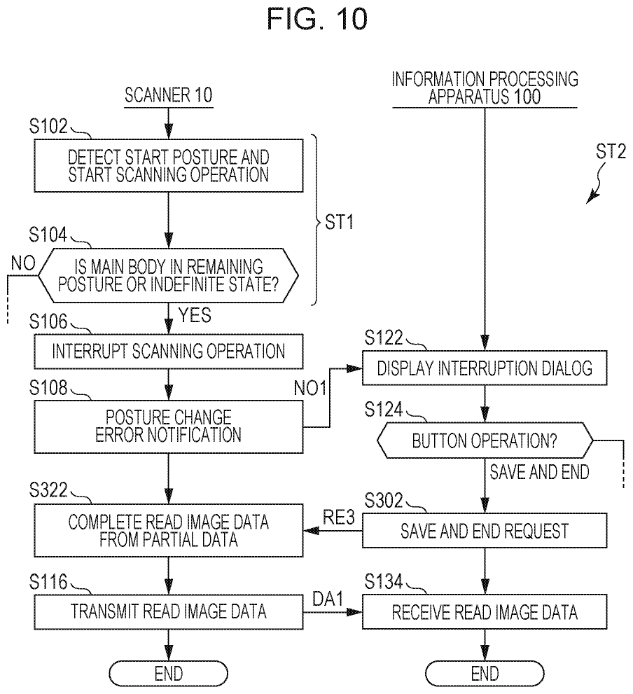

After the interruption dialog 410 is displayed, the information processing apparatus 100 branches the processing according to the operation of the buttons 411 to 413 by the user (S124). FIG. 6 shows processing when the “continue” button 411 is operated by the input device 105. For convenience of illustration, the processing when the “stop” button 413 is operated by the input device 105 is shown in FIG. 9, and the processing when the “save and end” button 412 is operated by the input device 105 is shown in FIG. 10.

When the operation of the “continue” button 411 is received, the information processing apparatus 100 requests the scanner 10 for the posture information IM1 indicating the posture P0 of the main body 30, and acquires the posture information IM1 from the scanner 10 (S126). The scanner 10 that has received the request for the posture information IM1 detects the posture P0 of the main body 30 by the posture detection section 55, acquires the posture information IM1 from the posture detection section 55, and transmits the acquired posture information IM1 to the information processing apparatus 100 (S110).

The information processing apparatus 100 that has received the posture information IM1 branches the processing depending on whether or not the posture P0 indicated by the posture information IM1 is the start posture Ps (S128). When the posture P0 indicated by the posture information IM1 is the remaining posture Pr or the indefinite state Pu, the information processing apparatus 100 displays, on the display portion 200, an error dialog 420 as illustrated in FIG. 8B (S130).

The error dialog 420 shown in FIG. 8B includes a message that the posture P0 of the main body 30 has been changed from the start of the scanning operation, such as “The posture of the main body is different from the initial tilt posture”, the message urging the main body 30 to return to the tilt posture P1. Of course, when the start posture Ps is the flat posture P2, the error dialog may include a message urging the main body 30 to return to the flat posture P2, such as “The posture of the main body is different from the initial flat posture”. In any case, the display examples are easy for the user to understand.

In the present specific example, the interruption dialog 410 shown in FIG. 8A and the error dialog 420 shown in FIG. 8B each include a message that the posture P0 of the main body 30 has been changed from the start of the scanning operation, and the message is displayed when the posture P0 indicated by the posture information IM1 is changed from the start of the scanning operation during the scanning operation. After the error dialog 420 is displayed, the information processing apparatus 100 returns the processing to S122. Therefore, the interruption dialog 410 is displayed after the error dialog 420 is displayed.

When the posture P0 of the main body 30 is changed to the start posture Ps, the posture P0 indicated by the posture information IM1 becomes the start posture Ps, and the processing proceeds to S132 in the determination processing of S128. In S132, the information processing apparatus 100 transmits the restart request RE1 for restarting the scanning operation to the scanner 10. The scanner 10 that has received the restart request RE1 uses the partial data DA2 generated by the reading section 20, and restarts the scanning operation (S112). Then, as shown in the state 314 in FIG. 7, the plurality of documents ORO included in the remaining document bundle SH1 are transported one by one by the document transport section 21 along the transport path 28. The scanner 10 leaves the partial data DA2 in page units in the state 313 when the scanning operation is interrupted, and reads the transported documents ORO one by one by the reading section 20 to sequentially add the obtained data in page units to the original partial data DA2.

After the scanning operation is restarted, the scanner 10 branches the processing depending on whether or not the reading of all the documents ORO is terminated (S114). When the unread document ORO remains, the scanner 10 returns the processing to S104. Therefore, when the posture P0 of the main body 30 remains the start posture Ps, the processing of S104 and S114 is repeated, and when the posture P0 of the main body 30 becomes the remaining posture Pr or the indefinite state Pu, the scanning operation is interrupted.

When the reading of all the documents ORO is terminated, the scanner 10 transmits the read image data DA1 generated in the RAM 14 to the information processing apparatus 100 (S116), and ends the processing shown in FIG. 6. The information processing apparatus 100 receives the read image data DA1 from the scanner 10 (S134) and ends the processing shown in FIG. 6. As shown in the state 315 of FIG. 7, the read image data DA1 generated in the RAM 14 includes the partial data DA2. Therefore, when the posture P0 changed from the start of the scanning operation is returned to the original posture during the scanning operation, the scanning operation is restarted to complete the read image data DA1 including the partial data DA2. In this way, even if the scanning operation is interrupted due to the change of the posture P0 of the main body 30, the partial data DA2 generated halfway is utilized by returning the posture P0 of the main body 30 to the original posture.

FIG. 9 illustrates processing when the “stop” button 413 shown in FIG. 8A is operated by the input device 105. The processing of S102 to S108 and S122 is as described above. Steps S202 and S222 correspond to the controller U2, the control function FU2, and the control step ST2.

When the operation of the “stop” button 413 is received in the determination processing of S124, the information processing apparatus 100 transmits, to the scanner 10, a read stop request RE2 for stopping the scanning operation without using the partial data DA2 (S202), and ends the processing shown in FIG. 9. The scanner 10 that has received the read request RE2 discards the partial data DA2, stops the scanning operation (S222), and ends the processing shown in FIG. 9.

By the above processing, while the scanning operation is interrupted due to the change of the posture P0 of the main body 30, the user can stop the scanning operation by operating the “stop” button 413. Therefore, the image reading apparatus 1 is convenient.

FIG. 10 illustrates processing when the “save and end” button 412 shown in FIG. 8A is operated by the input device 105. The processing of S102 to S108, S116, S122, and S134 is as described above. Steps S302 and S322 correspond to the controller U2, the control function FU2, and the control step ST2.

When the operation of the “save and end” button 412 is received in the determination processing of S124, the information processing apparatus 100 transmits, to the scanner 10, a save and end request RE3 for stopping the scanning operation after leaving the partial data DA2 (S302). The scanner 10 that has received the save and end request RE3 completes the read image data DA1 from the partial data DA2 (S322).

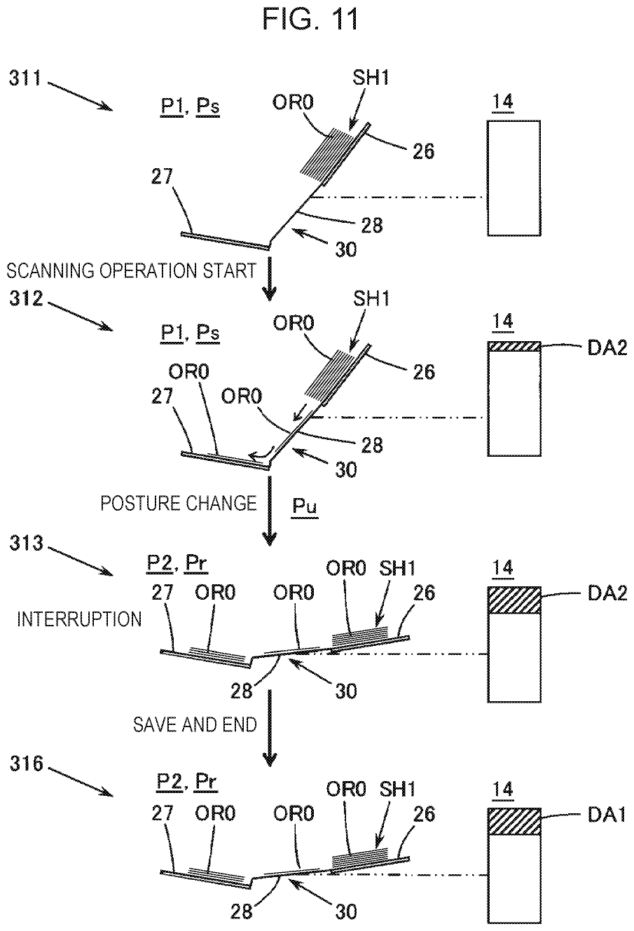

FIG. 11 schematically illustrates states 311 to 313 and 316 of the scanner 10 that changes according to the image processing shown in FIG. 10. The states 311 to 313 are as described above. When the posture P0 of the main body 30 becomes the remaining posture Pr or the indefinite state Pu during the scanning operation, and the “save and end” button 412 is operated, the partial data DA2 is converted into the read image data DA1. In the state 316, the reading of the remaining document ORO is stopped.

As described above, while the scanning operation is interrupted due to the change of the posture P0 of the main body 30, the user can stop the scanning operation after acquiring the scanned read image data DA1 by operating the “save and end” button 412.

As described above, since the scanning operation is interrupted when the posture P0 of the main body 30 is changed from the start of the scanning operation during the scanning operation, it is possible to suppress the situation where the document cannot be read normally due to the change of the posture of the main body. Then, the partial data DA2 generated halfway is utilized when the posture P0 of the main body 30 is returned to the original posture, the posture P0 of the main body 30 is prompted to be returned to the original posture when the posture P0 of the main body 30 is not returned to the original posture, and the partial data DA2 is also discarded or saved according to the instruction of the user. Therefore, according to the present specific example, in the image reading apparatus including the main body having a plurality of postures with different inclinations, it is possible to perform appropriate processing according to the changes in the posture after the interruption even when the scanning operation is interrupted due to the change of the posture of the main body.

4. Modification Example: in the present disclosure, various modification examples are conceivable.

For example, the plurality of postures of the main body may include postures other than the postures P1 and P2 described above. For example, assuming that an average inclination angle between the average inclination angle θ2 of the flat posture P2 and the average inclination angle θ1 of the tilt posture P1 is θ3, the plurality of postures P0 of the main body may include a semi-tilt posture of the inclination angle θ3. Of course, the plurality of postures of the main body may include the tilt posture P1 and the semi-tilt posture without the flat posture P2. Further, the main body may have a housing posture in which the document is not read, for example, a substantially vertical posture with an average inclination angle larger than the average inclination angle θ1 of the tilt posture P1.

The above processing can be changed as appropriate, such as by changing the order.

The interruption dialog 410 shown in FIG. 8A includes three buttons 411 to 413, but the number of the buttons included in the interruption dialog may be two or less, or four or more. For example, the buttons included in the interruption dialog may be only the two buttons 411 and 413 shown in FIG. 8A.

It is also possible that the scanner 10 alone performs image processing as the image reading apparatus 1. In this case, the display panel 17a of the scanner 10 may display the dialogs 410 and 420 as an example of the display portion.

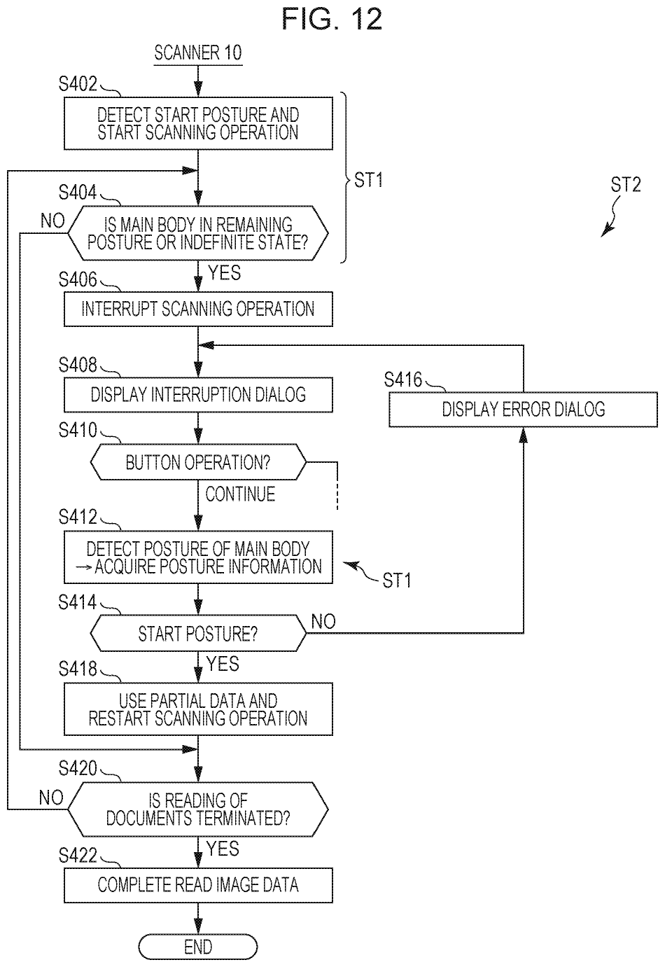

FIG. 12 illustrates image processing performed by the scanner 10. Here, steps S402 to S404 and S412 correspond to the posture acquisition section U1, the posture acquisition function FU1, and the posture acquisition step ST1. Steps S406 to S410 and S414 to S422 correspond to the controller U2, the control function FU2, and the control step ST2.

First, the scanner 10 acquires the posture information IM1 indicating the start posture Ps of the main body 30 from the posture detection section 55, and starts the scanning operation (S402). Next, the scanner 10 acquires the posture information IM1 indicating the posture P0 of the main body 30 from the posture detection section 55, and branches the processing depending on whether or not the posture P0 indicated by the posture information IM1 is one of the remaining posture Pr and the indefinite state Pu (S404). When the posture P0 of the main body 30 remains the start posture Ps, the processing of S404 and S420 is repeated.

When the posture P0 of the main body 30 becomes one of the remaining posture Pr and the indefinite state Pu, the scanner 10 interrupts the scanning operation (S406), and displays, on the display panel 17a, the interruption dialog 410 as shown in FIG. 8A (S408). When the operation of the “continue” button 411 is received (S410), the scanner 10 detects the posture P0 of the main body 30 by the posture detection section 55 and acquires the posture information IM1 from the posture detection section 55 (S412). When the posture P0 indicated by the acquired posture information IM1 is the remaining posture Pr or the indefinite state Pu (S414), the scanner 10 displays, on the display panel 17a, the error dialog 420 as shown in FIG. 8B (S416), and returns the processing to S408.

When the posture P0 indicated by the acquired posture information IM1 is the start posture Ps (S414), the scanner 10 uses the partial data DA2 and restarts the scanning operation (S418). When the reading of all the documents ORO is terminated (S420), the read image data DA1 including the partial data DA2 is completed (S422), and the image processing shown in FIG. 12 is ended. When the information processing apparatus 100 is coupled to the scanner 10, the scanner 10 may transmit the read image data DA1 to the information processing apparatus 100.

As described above, even in the image processing of the scanner alone, it is possible to suppress the situation where the document cannot be read normally due to the change of the posture of the main body, and to perform appropriate processing according to changes in the posture after interruption.

5. Conclusion: as described above, according to various aspects of the present disclosure, in the image reading apparatus including the main body having a plurality of postures with different inclinations, it is possible to provide a technology and the like capable of suppressing a situation in which a document cannot be read normally due to the change of the posture of the main body. Of course, the basic operation and effect described above can be obtained even by the technology consisting only of the constituent elements according to Aspects 1, 8, and 9 described above.

In addition, it is also possible to implement a configuration in which the configurations disclosed in the above-described examples are mutually replaced or combinations are changed, a configuration in which the configurations disclosed in the known technology and the above-described examples are mutually replaced or the combinations are changed, and the like. The present disclosure also includes these configurations and the like.

What is claimed is:

1. An image reading apparatus including a main body that performs a scanning operation of sequentially reading a plurality of documents by a reading section that reads the plurality of documents and a document transport section that transports the plurality of documents to the reading section, the main body having a plurality of postures with different inclinations, the image reading apparatus comprising:
a posture acquisition section that acquires posture information indicating the posture of the main body; and
a controller that controls an operation of the document transport section, wherein
the controller interrupts the scanning operation when the posture indicated by the posture information is changed from a start of the scanning operation during the scanning operation.

2. The image reading apparatus according to claim 1, wherein
in the plurality of postures, the posture of the main body at the start of the scanning operation is set as a start posture, and the rest is set as a remaining posture, and
the controller interrupts the scanning operation when the posture indicated by the posture information becomes one of the remaining posture and an indefinite state that is not any of the plurality of postures during the scanning operation.

3. The image reading apparatus according to claim 1, wherein
the controller displays, on a display portion, interruption information indicating interruption of the scanning operation when the posture indicated by the posture information is changed from the start of the scanning operation during the scanning operation.

4. The image reading apparatus according to claim 1, wherein
the controller displays, on a display portion, a message that the posture of the main body is changed from the start of the scanning operation when the posture indicated by the posture information is changed from the start of the scanning operation during the scanning operation.

5. The image reading apparatus according to claim 1, wherein
the reading section reads the plurality of documents to generate read image data, and
the controller completes the read image data including partial data by leaving the partial data generated by the reading section and restarting the scanning operation when the posture changed from the start of the scanning operation returns to an original posture during the scanning operation.

6. The image reading apparatus according to claim 5, wherein
the controller discards the partial data and stops the scanning operation when an instruction to stop the scanning operation without using the partial data is received while the scanning operation is interrupted, during the scanning operation.

7. The image reading apparatus according to claim 5, wherein
the controller completes the read image data from the partial data and stops the scanning operation when an instruction to leave the partial data and to stop the scanning operation is received while the scanning operation is interrupted, during the scanning operation.

8. A non-transitory computer-readable storage medium storing a control program for an image reading apparatus including a main body that performs a scanning operation of sequentially reading a plurality of documents by a reading section that reads the plurality of documents and a document transport section that transports the plurality of documents to the reading section, the main body having a plurality of postures with different inclinations, the control program causing a computer to realize:
a posture acquisition function of acquiring posture information indicating the posture of the main body; and
a control function of controlling an operation of the document transport section, wherein
the control function interrupts the scanning operation when the posture indicated by the posture information is changed from a start of the scanning operation during the scanning operation.

9. A control method of an image reading apparatus including a main body that performs a scanning operation of sequentially reading a plurality of documents by a reading section that reads the plurality of documents and a document transport section that transports the plurality of documents to the reading section, the main body having a plurality of postures with different inclinations, the control method comprising:
a posture acquisition step of acquiring posture information indicating the posture of the main body; and
a control step of controlling an operation of the document transport section, wherein
the control step includes interrupting the scanning operation when the posture indicated by the posture information is changed from a start of the scanning operation during the scanning operation.
